(19) United States
(12) Patent Application Publication
(10) Pub. No.: US 2013/0036313 A1
(43) Pub. Date: Feb. 7, 2013

(54) Persistent Encryption with XML Encryption

(71) Applicants: Jörg SCHWENK, Bad Sassendorf (DE); Christopher MEYER, Bochum (DE); Juraj SOMOROVSKY, Bochum (DE); Meiko JENSEN, Kiel (DE)

(72) Inventors: Jörg SCHWENK, Bad Sassendorf (DE); Christopher MEYER, Bochum (DE); Juraj SOMOROVSKY, Bochum (DE); Meiko JENSEN, Kiel (DE)

(21) Appl. No.: 13/563,817

(22) Filed: Aug. 1, 2012

(30) Foreign Application Priority Data
Aug. 5, 2011 (DE) 10 2011 109 610.1
Nov. 17, 2011 (DE) 10 2011 118 804.9

(51) Int. Cl. G06F 21/24

(52) U.S. Cl. 713/193

(57) ABSTRACT

A method for storing encrypted data in XML format is provided where parallel access by multiple users is possible

### TECHNICAL FIELD

The invention concerns encrypted data storage and, more particularly, a method for storing encrypted data in XML format where parallel access by multiple users is possible.

### BACKGROUND

The topic storage services is not new and is already offered by several technologies like Microsoft Sharepoint or OpenText. Those technologies offer users a storage space, which is located on some server cluster and accessible by web interfaces. However, the majority of those technologies does not support cryptographic protection for stored data at all. The occasional providers supporting cryptographic data protection typically store the encryption keys on untrusted cloud servers and thus offer an inadequate protection of users' data.

In terms of data encryption systems, there exist some wide-spread solutions such as TrueCrypt or eCryptFS that usually ensure only local protection and are therefore not suitable for distributed cloud storages. Their application becomes very inefficient as they only encrypt an entire partition or storage device (e.g. hard drive or USB flash drive). Moreover, by application of this technology parallel access and editing of documents by multiple users becomes impossible.

The next possible data encryption solution offers PGP. This nowadays widespread standard is applied for encryption of emails or individual files. It is thus more suitable for persistent data encryption than the frameworks encrypting the whole partitions. On the other hand, it still does not solve the problem of parallel document access by multiple users.

SSL/TLS enables securing the data on the transport level. The confidential data is secured only on the wire. The receiver can thus decrypt the encrypted blocks and see the plaintext content. Confidentiality has to be secured on the message level, which allows to persistently store the encrypted data.

XML Encryption is already applied in many systems and applications to secure the data on the message level. It is a part of Web Services Security specifications, which define scenarios considering message transport over several parties. We extend this technique by applying XML Encryption for persistent data storage.

Many applications already use XML as a data format, thus XML Encryption is a natural choice.

XML Encryption allows fine-grained encryption: It is possible to encrypt the whole document, to encrypt single elements, or to encrypt only the content of an element. In a preferred embodiment of this application several elements of the document will be encrypted.

Nowadays, XML Encryption is only used to protect the transmission of XML based data (e.g. in WS-Security): On decryption, information about algorithms and keys used is lost, because the <KeyInfo> element (or other elements that have the same function) will be deleted. If the plaintext data is re-encrypted, thus a new encryption key and probably a new encryption function will be selected.

It is clear that persistent encryption for data storage, or simultaneous access of multiple users to the same encrypted document, is thus not possible.

### BRIEF SUMMARY

We make this possible through this invention, which is specified in the claims. To enable persistent encryption and simultaneous access of many users to the same encrypted document, the information about encryption keys and algorithms must be kept along with the plaintext. Here two possibilities exist:
Possibility 1: The KeyInfo element (or another element describing similar information) remains in the cleartext document. A disadvantage of this solution is that eventually a schema validation performed on the cleartext may fail, because the <KeyInfo> element is not allowed in the XML Schema applied. Generally speaking, there may be a problem with computations on this data if an additional element is introduced.
Possibility 2: The key information is stored locally at the client side, e.g. in a database, and a reference to this database entry is added to the cleartext (e.g. as a novel XML attribute). This is our preferred solution, since nearly every XML Schema contains an extension option (e.g. for attributes). Applications which make use of the plaintext data may not care about attributes unknown to them. A general threat to this solution is that unknown attributes may be deleted by the client application. Here the data format to store the database reference must be selected with care for each application (e.g. webbrowser, text processing, Microsoft Excel, Calendar applications, . . . ).

Our solution describes a security mechanism for publicly available data, which can for example be stored on servers connected to the Internet (cloud storage such as Amazon S3 or Dropbox). In order to protect confidential user data, the documents are stored in an encrypted form. Management and indexing of the data (for example for searching purposes) is possible due to addition of unencrypted metadata.

### BRIEF DESCRIPTION OF THE DRAWINGS

FIG. 1 shows encrypted XML data with meta information needed for document decryption;

FIG. 2 illustrates decrypted XML data;

FIG. 3 shows XML metadata stored in the database under the handle “pers-223323227987”;

FIG. 4 shows decrypted XML data including a <KeyInfo> element; and

FIG. 5 shows another example in accordance with the invention.

### DETAILED DESCRIPTION

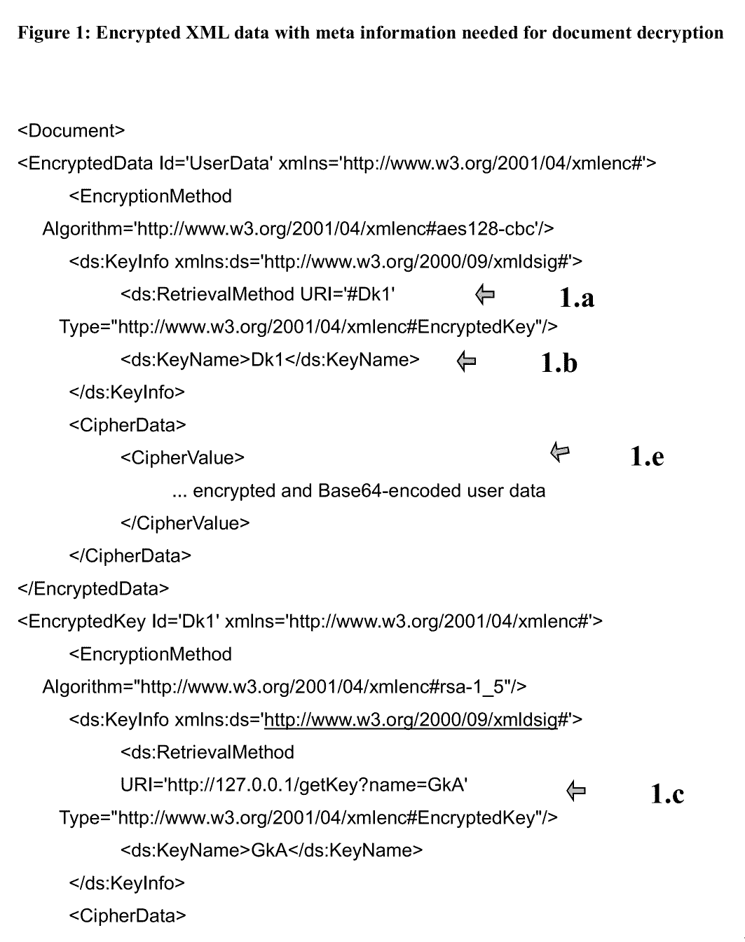

The innovation of our solution is the inclusion of plaintext information about the encryption key needed to decrypt the desired document parts. This is illustrated by the example in FIG. 1. The document key referencing can be achieved either by using a reference element URI=‘#Dk1’ (1.a) or by application of a unique identifier <ds:KeyName>Dk1</ds:KeyName> (1.b).

The data from FIG. 1 is stored in this form in a cloud. When the data is downloaded to a client's device, the key “GkA” (referenced by URI‘http://127.0.0.1/getKey?name=GkA’ (1.c)) has to be applied. This may be a public key pair or a symmetric key. If possible, this key should be stored on a place, which is protected against reading.

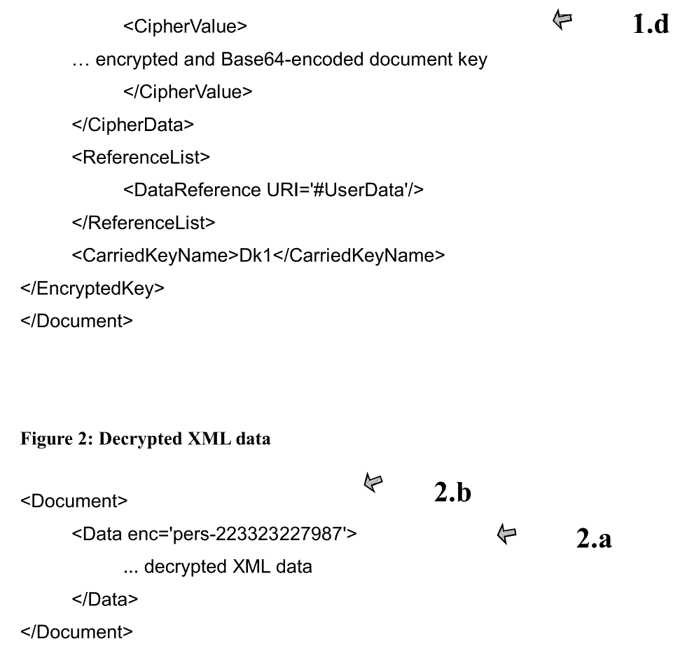

With the key “GkA” the device first decrypts the content of /Document/EncryptedKey/CipherData/CipherValue (1.d). The result of this decryption process is the key “Dk1”. With the key “Dk1” the device can subsequently decrypt /Document/EncryptedData/CipherData/CipherValue (1.e). The decryption result becomes the element /Document/Data (2.a), which is depicted in FIG. 2.

### Attribute-Based Solution

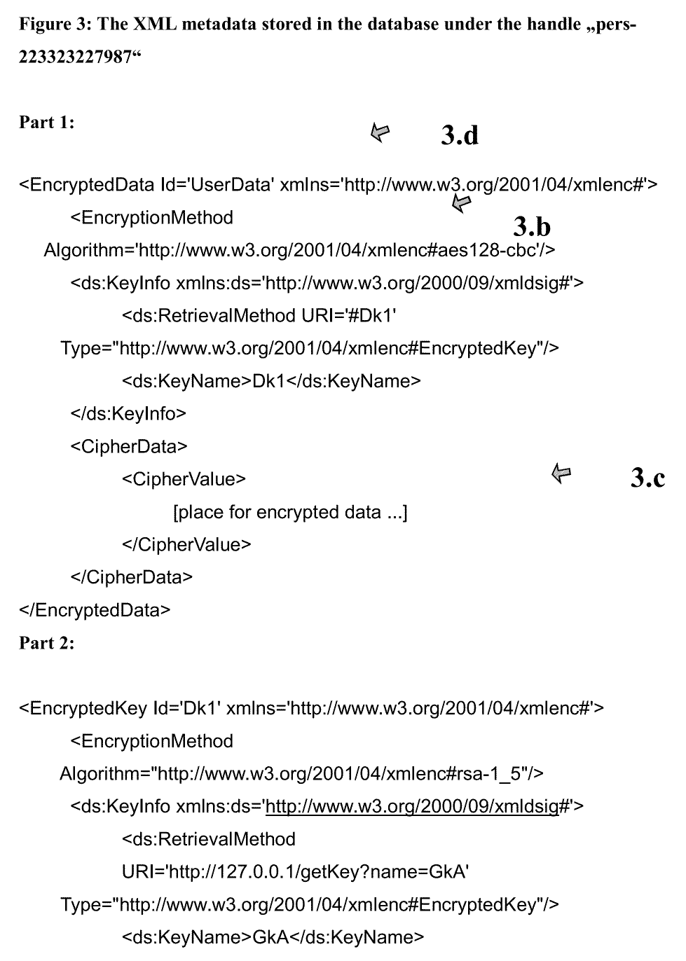

As can be seen in FIG. 2, the attribute “enc=‘pers-223323227987’” (2.b) is after the decryption process stored in the XML element. Thereby, the value of this attribute is chosen in the device and points to the database entry consisting of the data depicted in FIG. 3. After decrypting all the elements, the device can process the whole decrypted document. During the document processing the values of the “enc” attributes have to stay unchanged.

If the user wants to store the modified document in the cloud, according to the “enc” attribute the device uses the same key for the encryption. Thereby, the device works as follows:
Thanks to the “enc” attribute the device reads the database entry <EncryptedKey> element (Part 2) depicted in FIG. 3.
With the key “GkA” the device decrypts the key “Dk1” (3.a) positioned in the <CipherValue> element.
The “Dk1” key is used to encrypt the element marked with the “enc” attribute. Thereby, the device applies the encryption algorithm stored in the <EncryptionMethod> element (3.b).
The encrypted data is Base64-encoded and stored inside of the <CipherValue> element (3.c).
The <Data> element from FIG. 2 is replaced by the newly created <EncryptedData> element from FIG. 3 (Part 1). The <EncryptedData> element represents the first child element of the root <Document> element.
The second child element of the <Document> element from FIG. 2 becomes the <EncryptedKey> element from FIG. 3 (Part 2).
The device updates the metadata of the whole document; e.g. an attribute “UserData” is included into the <EncryptedData> element (3.d).

In addition to this concrete solution there exist various different solutions, which are compatible with the XML Encryption specification.

### KeyInfo-Based Solution

The next solution for persistent data storage offers storage of the whole <KeyInfo> element in the decrypted document. Thereby, it should be decided, where to put the <KeyInfo> element. This depends on the XML Schema of the processed document and on the business logic processing (the business logic data must not be affected by this <KeyInfo> element inclusion).

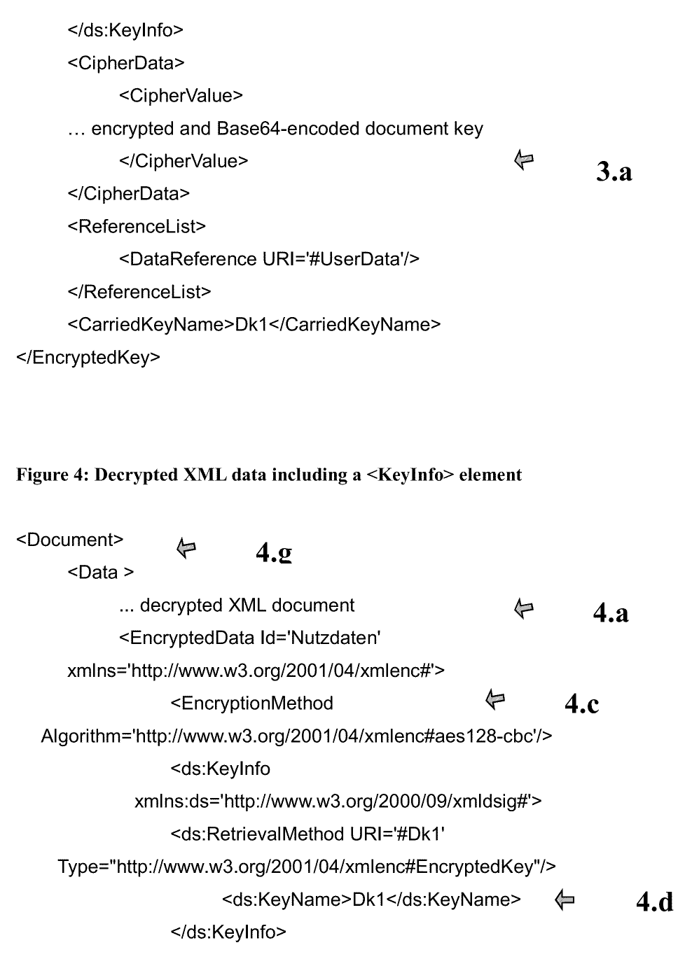

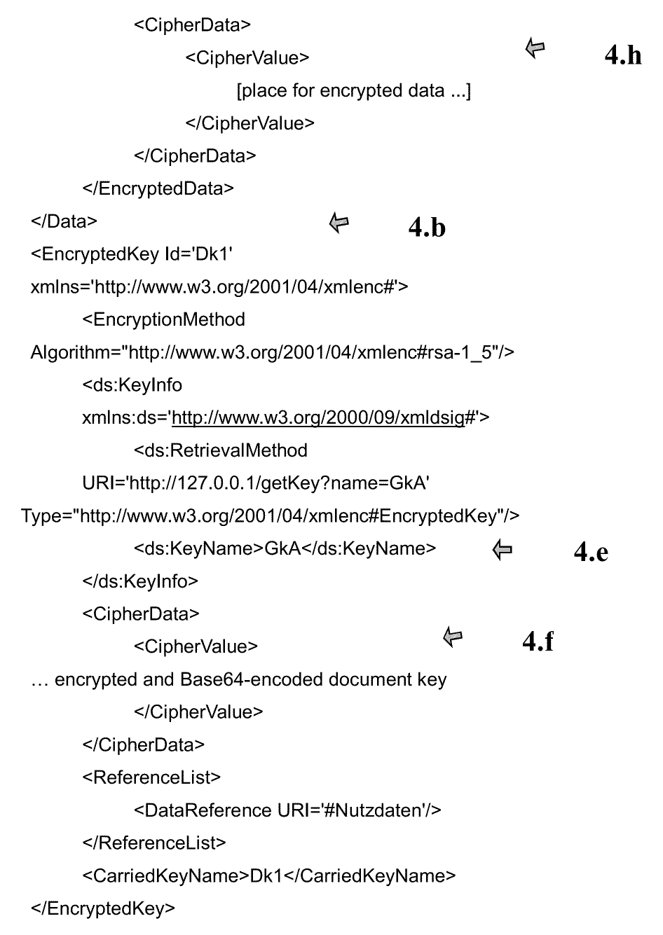

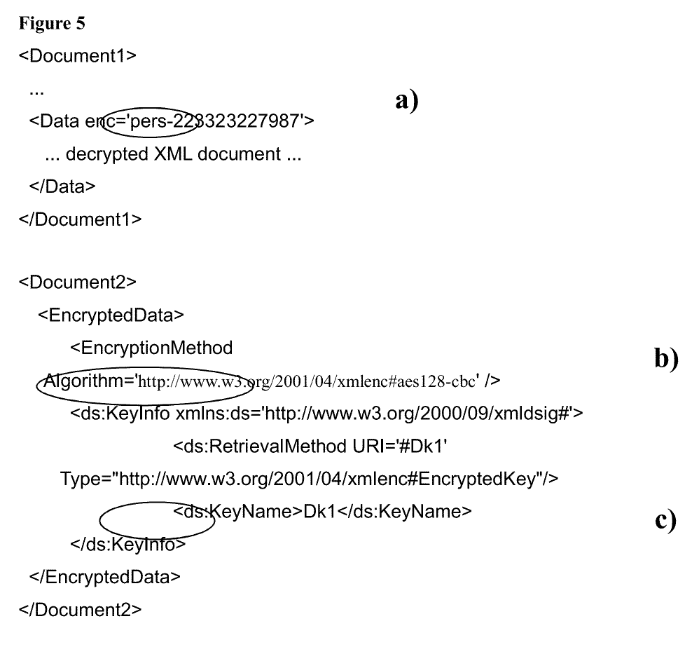

One example of this approach gives FIG. 4. As can be seen in the depicted document, the <EncryptedData> element is inserted into the element carrying the decrypted data (4.a). The <EncryptedKey> element is inserted as a child directly into the <Document> root element (4.b).

The places for insertion of <KeyInfo> describing elements can be moved depending on the XML Schema and the business logic processing. Thereby, it has to be ensured that the security component knows which elements will be encrypted again.

After the decryption, the plaintext document can be processed. However, the elements <EncryptedKey> and <EncryptedData> must not be modified.

When the document is moved to the cloud, the same key is used for the encryption process as was used for the decryption process. Thereby, the device proceeds as follows:
Thanks to the position of the <EncryptedData> element (or an additional information in this element) the device knows that the <Data> element must be encrypted. For the encryption the “aes128-cbc” algorithm and the key “Dk1” is used (taken from 4.c and 4.d).
The “GkA” key (4.e) is used for the <CipherValue> decryption (4.0 placed inside of the <EncryptedKey> element (4.b). The result of this decryption is the key “Dk1”.
The “Dk1” key is used for the <Data> element (4.g) encryption. Thereby, the <EncryptedData> element (4.a) is not considered and is excluded from the encryption process.
The encrypted data are Base64 encoded and inserted into the <CipherValue> element (4.h).
Finally, the resulting document is structured as the document depicted in FIG. 1.

In addition to this concrete solution there exist various different solutions, which are compatible with the XML Encryption specification.

### Summary

1 Persistent Encryption with XML Encryption

2.1 XML is a widely used data format applied in many systems. XML Encryption is thus a favorable solution for data encryption in these systems. However, simultaneous access of multiple users on the same encrypted document is not possible.

2.2 Persistent encryption and a simultaneous access of multiple users to the same document can be achieved by including a key information into the plaintext document. For this purpose, an attribute can be added to the decrypted element (5.a). The attribute references data that is defined outside of the document or inside of the same document. The referenced data contains details about the used algorithms (5.b), keys, and additional information (5.c). If the attribute references a (decrypted or encrypted) key, the key can be found in the same document as well as outside of the document.

2.3 The solution is applicable to all the data that can be depicted in the XML format. It is suitable for short-time as well as long-time persistence of encrypted data. Thereby, it is not relevant, if the data was encrypted for the transport or storage purposes.

1. A method for storing encrypted data in XML format, wherein parallel access by multiple users is possible.

2. A method according to patent claim 1, wherein write access is possible.

3. A method according to patent claim 1, wherein for decryption, the information on the used keys is stored locally and a reference to these stored keys is added to the plain text.

4. A method according to patent claim 3, wherein the reference is an attribute.

5. A method according to patent claim 3, wherein the reference is a sub-element.

6. A method according to patent claim 3, wherein the reference is made in the text block.

7. A method according to patent claim 1, wherein parallel access by multiple users divided into multiple groups is possible.

8. A method according to patent claim 1, wherein the encryption can be either symmetrical or asymmetrical.

9. A method according to patent claim 1, wherein the encryption is carried out by a combination of symmetrical and asymmetrical methods.

10. A method according to patent claim 3, wherein the reference itself is stored encrypted.
